(19) United States
(12) Patent Application Publication
(10) Pub. No.: US 2005/0013453 A1
(43) Pub. Date: Jan. 20, 2005

(54) Flat panel loudspeaker system for mobile platform

(76) Inventor: Kwun-Wing W. Cheung, Shoreline, WA (US)

Correspondence Address: HARNESS, DICKEY & PIERCE, P.L.C., P.O. BOX 828, BLOOMFIELD HILLS, MI, 48303, US

(21) Appl. No.: 10/623,408

(22) Filed: Jul. 18, 2003

(51) Int. Cl. H04R 25/00; H04R 11/02; H04R 9/06

(52) U.S. Cl. 381/152; 381/302; 381/334; 381/389; 381/431

(57) ABSTRACT

A high fidelity sound system for a mobile platform is provided. The system includes a plurality of panels forming interior surfaces of a passenger cabin of the mobile platform. The system additionally includes a plurality of exciters. Various selected panels have at least one exciter is affixed thereto, wherein the exciters are adapted to resonate the panels to thereby generate sound waves. The system further includes a processing center that controls signals that drive the exciters. The signals are modified by the processing center so that each exciter generates sound waves within a specific frequency bandwidth that is based on the panel material or structure to which each exciter is affixed.

### FIELD OF INVENTION

The invention relates generally to public address systems for mobile platforms, such as aircraft, buses, trains and ships. More specifically the invention relates to providing a high fidelity mobile platform audio system utilizing wall panels, floor panels and/or ceiling panels of the mobile platform as flat panel speakers.

### BACKGROUND OF THE INVENTION

Current mobile platform public address (PA) loudspeaker and audio systems have limited frequency response in both high and low frequencies. Known passenger cabin amplifiers and loudspeakers are solely designed for vocal application of frequencies ranging from 300 Hz to 5 kHz. This frequency range is incompatible for music audio having a frequency range from 20 Hz to 20 kHz. Additionally, due to bandwidth limitations of the speakers, mobile platform PA loudspeaker systems typically have poor sound quality when delivering broadcasts from crew members of the mobile platform. Another reason for the poor sound quality is due to a “point source” characteristic of typical loudspeakers that produce localized sound. More specifically, listening on axis of a point source speaker will cause the listener to hear direct high frequencies and a robust sound level from the speaker. However, listening off axis will have less high frequencies, a weaker sound level, and poor audio quality.

Therefore, the localized audio energy of current point source speakers used in mobile platforms is not distributed evenly throughout the passenger cabin. This uneven distribution of the sound causes the audio quality to sound too loud to the passengers on axis, and not clear to the passenger off center.

Furthermore, installation of a current point source loudspeaker requires that a hole be cut in an interior panel of the passenger cabin and that a grill be placed over the installed speaker. Further yet, relocation of seats within the passenger cabin may require relocation of the speakers. Therefore, installation of known PA systems in mobile platforms is labor intensive, requires excessive parts, and is costly.

### SUMMARY OF THE INVENTION

According to a preferred embodiment of the present invention, a high fidelity sound system for a mobile platform is provided. The system includes a plurality of panels forming interior surfaces of a passenger cabin of the mobile platform. The system additionally includes a plurality of exciters. Various selected panels have at least one exciter is affixed thereto, wherein the exciters are adapted to resonate the panels to thereby generate sound waves. The system further includes a processing center that controls signals that drive the exciters. The signals are modified by the processing center so that each exciter generates sound waves within a specific frequency bandwidth that is based on the panel material or structure to which each exciter is affixed.

According to another preferred embodiment, a method for producing high fidelity sound within a passenger cabin of a mobile platform is provided. The method includes affixing at least one of a plurality of exciters to selected panels that form interior surfaces of the passenger cabin. The method additionally includes driving each exciter to resonate the panels to thereby generate sound waves. The method further includes processing the signals that drive the exciters to contour the sound waves generated by each exciter based on the panel to which each exciter is affixed. Contouring the sound waves produces high fidelity sound throughout the passenger cabin.

### BRIEF DESCRIPTION OF THE DRAWINGS

The present invention will become more fully understood from the detailed description and accompanying drawings, wherein;

FIG. 1 is a schematic of a high fidelity sound system for a mobile platform in accordance with a preferred embodiment of the present invention;

FIG. 2 is an illustration of an exemplary exciter shown in FIG. 1;

FIG. 3 is an illustration of another exemplary exciter shown in FIG. 1;

FIG. 4 is an illustration of a sound field produced by the sound system shown in FIG. 1, in accordance with a preferred embodiment of the present invention; and

FIG. 5 is an illustration of a sound field produced by the sound system shown in FIG. 1, in accordance with another embodiment of the present invention.

### DETAILED DESCRIPTION OF THE INVENTION

The following description of the preferred embodiment(s) is merely exemplary in nature and is in no way intended to limit the invention, its application or uses.

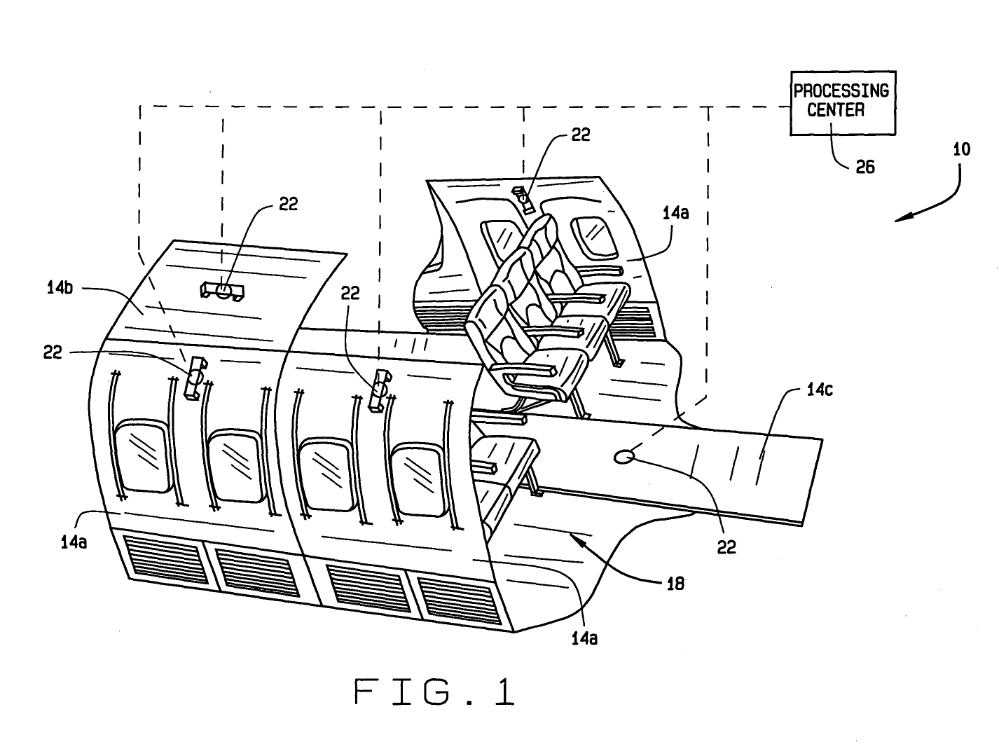

Referring to FIG. 1, a high fidelity sound system 10 for a mobile platform is shown. The sound system 10 includes plurality of panels 14 that form a passenger cabin 18, shown in a sectioned perspective view. The panels 14 include at least one side panel 14a, at least one ceiling panel 14b and at least one floor panel 14c. The sound system 10 additionally includes a plurality of exciters 22 wherein at least one exciter 22 is affixed to various panels 14a, 14b and 14c throughout the passenger cabin 18. The exciters 22 resonate the panels 14a, 14b and 14c to thereby generate sound waves that emanate from the panels 14a, 14b and 14c. Thus, the panels 14a, 14b and 14c are not only used to form the interior surfaces of the passenger cabin 18, but also as flat panel speakers. The exciters 22 can be any suitable device for generating sound waves that emanate from the panels, for example transducers commercially available from Slab Sound of Auckland, New Zealand. Each exciter 22 distributes audio energy having a wide frequency range evenly across a large portion the panels 14a, 14b or 14c that surrounds each exciter 22. Additionally, the sound emanating from the panels 14a, 14b and 14c has wide listening angle, for example approximately 180°. Having a wide frequency range and listening angle enables the sound system 10 to provide excellent voice sound quality for use as a public address (PA) system and excellent audio quality for use as an entertainment sound system.

In one embodiment, the exciters 22 are affixed to strategically selected panels 14a, 14b and 14c so that the exciters 22 are distributed throughout the passenger cabin in a support array. That is, the exciters 22 are affixed to strategically selected panels 14a, 14b and 14c so that the sound emanating from each selected panel 14a, 14b and 14c acoustically blends with the sound emanating from the other selected panels 14a, 14b and 14c. Therefore, sound fills a large sound field that includes all normal listening areas of the passenger cabin 18. Alternatively, the exciters 22 can be affixed to each panel 14a, 14b and 14c in the passenger cabin 18. In which case, the sound emanating from each selected panel 14a, 14b and 14c is also acoustically blended with the sound emanating from the other selected panels 14a, 14b and 14c.

The sound system 10 further includes a processing center 26 that controls, i.e. processes, audio signals that control the exciters 22. In one embodiment, the processing center 26 is a software based system that utilizes a processor and software programs to modulate the signals. Alternatively, the processing center 26 is a hardware based system that uses electrical circuits, components and devices such as a frequency equalizer, a cross-over point adjustment device and a frequency delay device (not shown) to modulate the signals. In yet another embodiment, the processing center 26 can use a combination of software and hardware to modulate the signals. Furthermore, it is envisioned that the processing center 26 can be a stand-alone system included in the mobile platform, or a sub-system of a computer based main control system (not shown) of the mobile platform.

In one embodiment, the processing center 26 sends the modulated signals to the exciters 22 via hard-wired electrical connections. In an alternate embodiment, the processing center 26 transmits the modulated signals to the exciters 22 via wireless signals. For example, the sound system 10 can utilize infrared (IR) or electromagnetic, i.e. radio frequency (RF), signals to communicate between the processing center 26 and electronics of the exciters 22 that can be built into the exciters 22 or located near the exciters 22.

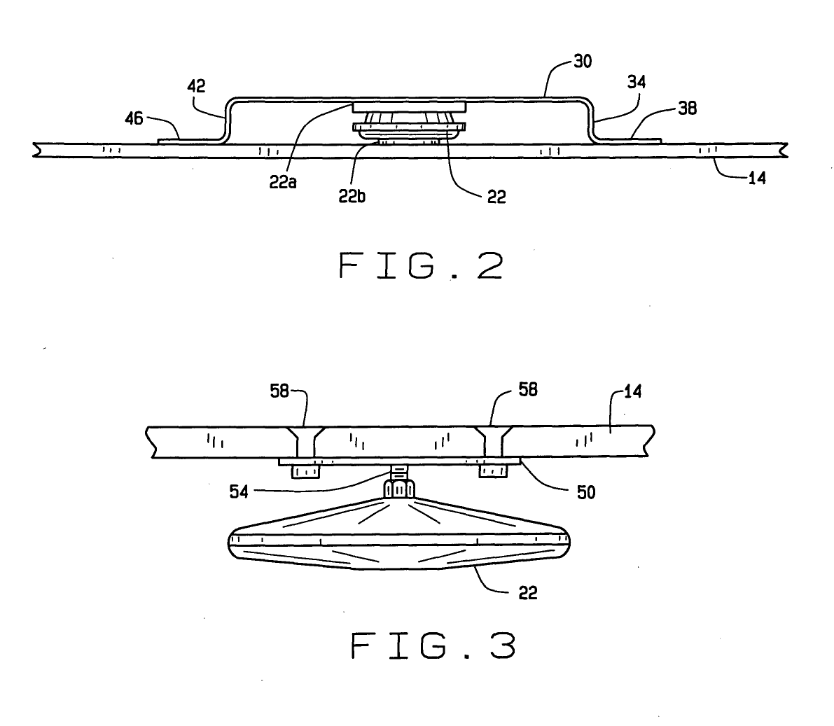

Referring to FIG. 2, an exemplary exciter 22 coupled to an attachment bracket 30 is shown. The attachment bracket 30 includes a first leg 34 having a first foot 38 and a second leg 42 having a second foot 46. A back side 22a of the exciter 22 is coupled to the bracket 30 in any suitable fashion, e.g. riveting, gluing, bolting, or spot welding. A front side 22b of the exciter 22 is affixed to the panel 14 using a suitable adhesive. The panel 14 shown can be the sidewall panel 14a, the ceiling panel 14b and/or the floor panel 14c. However, the exemplary exciter 22 and bracket 30 combination shown is best suited for used with the sidewall panel 14a and the ceiling panel 14a. The adhesive used to affix the front side 22b to the panel 14 is an adhesive that will securely bond the exciter 22 to the panel 14 and cure to a temperament and rigidity that will allow excitations, or vibrations, from the exciter 22 to be cleanly and seamlessly transferred to the panel 14. That is, the adhesive allows the excitations to transfer to the panel substantially unchanged. Additionally, the adhesive can endure a wide range of temperature without degradation of its bonding characteristics. For example, a suitable adhesive would be an epoxy, acrylic or cyano-acrylate adhesive that can endure temperatures from −40° F. (−40° C.) to 180° F. (83° C.). The first foot 38 and the second foot 46 are likewise affixed to the panel 14 using the same suitable adhesive.

Referring to FIG. 3, another exemplary exciter 22 coupled to a mounting plate 50 is shown. The exciter 22 is coupled to the mounting plate 50 via a coupling rod 54. One end of the coupling rod 54 is solidly coupled to the mounting plate 50 while an opposing end of the coupling rod 54 is solidly coupled to the exciter 22. The mounting plate 50 and the exciter 22 are solidly coupled to the coupling rod 54 in a locking fashion that will not allow the mounting plate 50 or the exciter 22 to separate from the coupling rod due to vibration of the exciter 22. For example, the mounting plate 50 and the exciter 22 can be welded to or irreversibly threaded on the coupling rod 54. Furthermore, the mounting plate 50 and the exciter 22 are solidly coupled to the coupling rod 54 such that excitations, or vibrations, from the exciter 22 are cleanly and seamlessly transferred to the mounting plate 50 substantially unchanged.

The mounting plate 50 is coupled to the panel 14 using one or more connecting devices 58. The connecting devices 58 are adapted to firmly affix the mounting plate 50 to the panel 14 without crushing the panel 14, which would cause distortion in the sound waves emanated from the panel 14. Additionally, the connecting devices 58 affix to the mounting plate 50 to the panel 14 such that the panel 14 will not delaminate due to vibrations of the exciter 22. Although the connecting devices 58 are shown as nuts and bolts, the connecting devices 58 can be any suitable connecting devices such as rivets or screws. The mounting plate 50 is firmly affixed to the panel 14 such that excitations, or vibrations, from the exciter 22 are cleanly and seamlessly transferred through the coupling rod 54 and the mounting plate 50 to the panel 14. The panel 14 shown can be the sidewall panel 14a, the ceiling panel 14b and/or the floor panel 14c. However, the exemplary exciter 22 and mounting plate 50 combination shown is best suited to be affixed to the floor panel 14c.

Referring now to FIG. 1, the processing center 26 transmits audio signals to each of the exciters 22. The audio signals drive the exciters 22 causing the exciter 22 to vibrate and thereby generate sound waves that emanate from the respective panels 14a, 14b or 14c. Each type of panel, i.e. sidewall panel 14a, ceiling panel 14b, and floor panel 14c, has its own resonance character and frequency range limitation. For example, although the floor panel 14c can produce low, mid-range and some high frequencies sound waves, the floor panel 14c is well suited to perform low frequency tasks of the sound system 10. Similarly, although the sidewall panel 14a can produce high, mid-range, and some low frequencies sound waves, the sidewall panel 14a is better suited for mid-range to high frequencies tasks of the sound system 10. Therefore, the processing center 26 processes, i.e. modulates, each signal to contour the sound waves generated by each exciter 22 to have specific audio levels, frequencies within specific bandwidths, and frequency equalization.

The bandwidths are determined based principally on the material characteristics of the panel 14 to which each exciter 22 is affixed, the location of the panel 14 within the passenger cabin and the mounting structure used to mount the panel 14 within the mobile platform. Additionally, certain parts or assemblies of the panels 14, such as window assemblies, will factor into the determination of bandwidths. More specifically, signals are transmitted to the exciters 22 so that the frequencies of sound waves that emanate from the sidewall panels 14a are within a first bandwidth, the frequencies of sound waves that emanate from the ceiling panels 14b are within a second bandwidth, and the frequencies of sound waves that emanate from the floor panels 14c are within a third bandwidth. The entire bandwidth that each panel 14 is capable of producing without distortion may not necessarily be used. For example, it would not be desirable for the sidewall panels 14a and/or the ceiling panels 14b to produce excessive low frequencies even though the sidewall and ceiling panels 14a and 14b may be capable of producing such low frequencies. This would generate too much vibration for passengers sitting near the side panels 14a, and could cause damage to the ceiling panels 14b.

The processing center 26 additionally processes the signals to contour the sound waves within each bandwidth such that the amplitudes of sound waves having frequencies near the outer boundaries of each bandwidth are progressively attenuated. The processing center 26 further modulates the signals such that the amplitudes of the sound waves with frequencies between the outer boundary frequencies are relatively consistent. For example, if the processing center 26 modulates the signals so that sound waves between approximately 200 Hz and 18 kHz emanate from the sidewall panels 14a, the outer boundary frequencies would be frequencies near 200 Hz and 18 kHz, e.g. 200-400 Hz and 15-18 kHz, respectively. In this example, the processing center 26 would modulate the signals to contour the sound waves so that the amplitudes of sound waves having frequencies from approximately 200-400 Hz would be progressively attenuated. Likewise, the amplitudes of the sound waves having frequencies from approximately 15 to 18 kHz would be progressively attenuated. Conversely, the amplitudes of the sound waves having frequencies from approximately 400 Hz to 15 kHz will be effectively consistent.

Thus, the amplitude, i.e. intensity or volume level, of the sound waves with outer boundary frequencies will be progressively attenuated. This progressive attenuation reduces distortion caused by frequency cross-over between the different bandwidths and the inability of the panels 14 to clearly resonate at the outer boundary frequencies. The processing center 26 further modulates the signals so that the phase timing of all the sound waves are coordinated. This provides a smooth, high quality audio environment when the sound waves emanating from the panels 14 are aggregated.

In one embodiment, the processing center 26 modulates signals transmitted to the exciters 22 affixed to sidewall panels 14a so that sound waves having frequencies between approximately 200 Hz and 18 kHz are generated. The outer boundary frequencies, e.g. approximately 200-400 HZ and 15-18 kHz, will be progressively attenuated, while frequencies from approximately 400 Hz to 15 kHz will have approximately level amplitudes. Similarly, the processing center 26 modulates signals transmitted to the exciters 22 affixed to ceiling panels 14b so that sound waves having frequencies between approximately 300 Hz and 18 kHz are generated. The outer boundary frequencies, e.g. approximately 300-600 Hz and 15-18 kHz, will be progressively attenuated, while frequencies from approximately 600 Hz to 15 kHz will have approximately level amplitudes. Likewise, signals transmitted by the processing center 26 to the exciters 22 affixed to the floor panels 14c are modulated so that sound waves having frequencies between approximately 40 Hz and 12 kHz are generated. The outer boundary frequencies, e.g. approximately 40-60 Hz and 10-12 kHz, will be progressively attenuated, while frequencies from approximately 60 Hz to 10 kHz will have approximately level amplitudes.

In another embodiment, the floor panel 14c is covered by a thick material, such as carpet, that attenuates the amplitudes of the mid-range to high frequency sound waves generated by the floor panel 14c. In this embodiment, signals transmitted by the processing center 26 to the exciters 22 affixed to the floor panels 14c are modulated so that sound waves having frequencies between approximately 40 Hz and 12 kHz are generated. However, due to the natural attenuation of the mid-range to high frequencies, processing center 26 modulates the signals to increase the amplitude of the upper boundary frequencies. For example, the amplitudes of frequencies from approximately 8 kHz to 12 kHz are increased to provide a smooth transition between the sound waves emanating from the floor panels 14c and the sound waves emanating from the other panels 14. Conversely, the lower boundary frequencies, e.g. approximately 40-60 Hz, are progressively attenuated.

In operation the processing center 26 receives an audio signal from an audio source such as a microphone or audio/visual entertainment device, e.g. a audio or video system. The processing center 26 then splits the signal into two or three separate signals, depending on the number of different types of panels 14 that are utilized in the sound system 10. For example, if the sound system 10 incorporates exciters 22 affixed to only sidewall and floor panels 14a and 14c, the processing center 26 will split the audio signal into two separate signals. However, if the sound system 10 incorporates exciters 22 affixed to sidewall, ceiling and floor panels 14a, 14b and 14c, the processing center 26 will split the audio signal into three separate signals. The processing center 26 then processes the separate signals to contour the sound waves in accordance with the acoustical characteristics of the panel 14 to which the signal is to be sent. The processed signals are then transmitted to the appropriate exciters 22.

As described above, the processing center 26 can be a software based system that utilizes a processor and software programs to modulate the signals and contour the sound waves emanated from the panels 14. In which case, the regulation of the sound waves within specific bandwidths, the attenuation of the outer boundary frequencies, and the coordination of the phase timing are all accomplished via suitable software. Alternatively, the processing center 26 can be a hardware based system. In which case electrical circuits, components and devices are implemented to regulate the sound waves within specific bandwidths, attenuate the outer boundary frequencies, and coordinate the phase timing. For example, a frequency equalizer is utilized to modulate the signals so that each exciter 22 generates sound waves having frequencies within a specific bandwidth that is based on the panel 14 to which the exciter is affixed. Additionally, a cross-over point adjustment device is utilized to modulate the signals so that the amplitudes of the sound waves having frequencies near the outer boundaries of each bandwidth are progressively attenuated to reduce distortion and create a smooth frequency transition. Such distortion is caused by non-linear frequency crossover and the inability of the panels 22 to resonate at the outer boundary frequencies. Furthermore, a frequency delay device is utilized to modulate the signals so that a phase timing of the sound waves generated by each exciter 22. The phase timing is adjusted or corrected to coordinate with the phase timings of the other sound waves so that the panels 22 are performing audio reproduction correctly. Additionally, adjusting the phase timing helps to mate the sound waves from one panel 22 with the sound waves from other panels 22.

The exciters 22 are strategically distributed throughout the passenger cabin in a support array such that high fidelity sound fills a large sound field that includes all normal listening areas of the cabin. It will be understood that the exciters 22 are preferably affixed to the back side of the sidewall and ceiling panels 14a and 14b, and to the bottom side of the floor panels 14c. Affixing the exciters 22 to back side and bottom of panels 22 obscures the exciters 22 from the view of passengers within the passenger cabin 18, and prevents the exciters 22 from being damaged by the passengers.

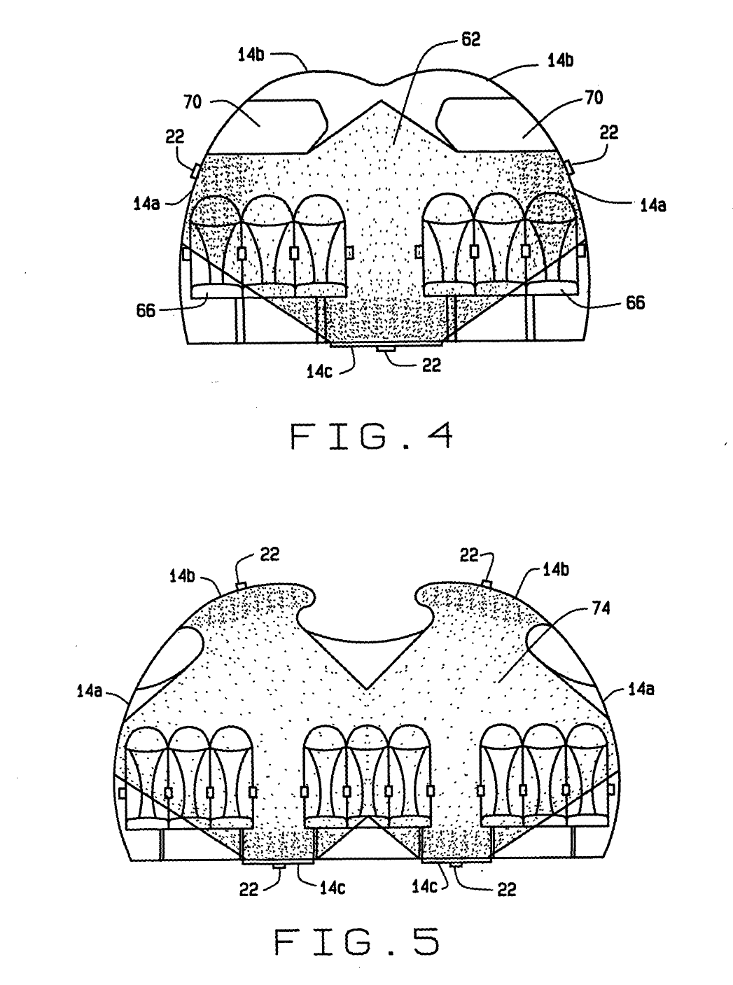

Referring to FIG. 4, a sound field 62 generated by the sound system 10 is illustrated, in accordance with a preferred embodiment. In this embodiment, exciters 22 are affixed to sidewall panels 14a and floor panels 14c of the passenger cabin 18. At least one exciter 22 is affixed to each sidewall panel 14a and at least one exciter 22 is affixed to selected floor panels 14c. For example, exciters 22 can be located approximately every ten feet, in the longitudinal direction, along the floor panels 14c that form a passenger aisle of the mobile platform. The exciters 22 affixed to sidewall panels 14a are affixed at an upper portion of the sidewall panels 14a that is approximately adjacent and slightly above the head of passengers sitting in the seats 66 nearest the sidewall panels 14a. Each exciter 22 affixed to the floor panels 14c are located near the center of each floor panel 14c along the passenger aisle.

As illustrated, this arrangement is well suited for single aisle mobile platforms and creates the sound field 62 that includes all normal listening areas of the passenger cabin 18. The sound field 62 includes an area from below overhead storage bins 70 to approximately the mid-torso of a seated passenger. Therefore, all seated passengers are within the sound field and can enjoy the high fidelity sound produced by the sound system 10. Additionally, the sound field 62 includes the area above the floor panels 14c to a point near the ceiling of the passenger cabin 18. Thus, a passenger traversing the passenger aisle can also enjoy the high fidelity sound produced by the sound system 10. To increase the dynamic intensity and/or magnitude of the sound field 62 more than one exciter can be affixed at more than one location of each of the sidewall and/or floor panels 14a and 14c. Additionally, the dynamic intensity and/or magnitude of the sound field 62 can be increased by adding exciters 22 affixed to the ceiling panels 14b. Adding exciter 22 to the ceiling panels 14b would require additional processing by processing center 26 to mix the sound emanated from the ceiling panels 14b with sound emanated from the sidewall and floor panels 22a and 22c.

Referring to FIG. 5, a sound field 74 generated by the sound system 10 is illustrated, in accordance with another preferred embodiment. In this embodiment, exciters 22 are affixed to ceiling panels 14b and floor panels 14c of the passenger cabin 18. At least one exciter 22 is affixed to each ceiling panel 14b and at least one exciter 22 is affixed to selected floor panels 14c. For example, exciters 22 can be located approximately every ten feet, in the longitudinal direction, along the floor panels 14c that form passenger aisles of the mobile platform. The exciters 22 affixed to ceiling panels 14a are centrally located on the ceiling panels 14a spaced a desirable distance apart. For example, a six foot long ceiling panel 14b would have two exciters 22 spaced four feet apart. Similarly, each exciter 22 affixed to the floor panels 14c are located near the center of floor panels 14c.

As illustrated, this arrangement is well suited for twin aisle mobile platforms and creates the sound field 74 that includes all normal listening areas of the passenger cabin 18. The sound field 74 includes an area from below the ceiling panels 14b to approximately the mid-torso of a seated passenger. Therefore, all seated passengers can enjoy the high fidelity sound produced by the sound system 10. Additionally, the sound field 74 includes the area above the floor panels 14c to the ceiling panels 14b. Thus, passengers traversing the passenger aisles can also enjoy the high fidelity sound produced by the sound system 10. To increase the dynamic intensity and/or magnitude of the sound field 74 more than one exciter can be affixed at more than one location of each of the ceiling and/or floor panels 14b and 14c. Additionally, the dynamic intensity and/or magnitude of the sound field 74 can be increased by adding exciters 22 affixed to the sidewall panels 14a. Adding exciter 22 to the sidewall panels 14a would require additional processing by processing center 26 to mix the sound emanated from the sidewall panels 14a with sound emanated from the ceiling and floor panels 22b and 22c.

In another preferred embodiment, the sound system 10 incorporates a redundant backup safety configuration. More specifically, at least two exciters 22 are affixed to selected ones, or all, of the panels 14 so that if one primary exciter 22 fails, a redundant backup exciter 22, also affixed to the panel 14, provides excitation to the panel 14. Therefore, the panel 22 does not have to be removed to repair or replace the faulty exciter 22. The signals transmitted by the processing center 26 can be switched from the primary exciter 22 to the redundant back up exciter 22 either electronically by the processing center 26 or manually by a switch (not shown) located on each panel 14 having a redundant exciter 22 affixed thereto. For example, in the case of a side panel 14a having a primary and a redundant back up exciter 22 affixed thereto, if the primary exciter 22 experienced a failure the signals transmitted from the processing center 26 can be easily redirected to the redundant back up exciter 22.

The sound system 10 is a high fidelity sound system especially well suited for mobile platforms. Sound system 10 incorporates the passenger cabin sidewall, ceiling and/or floor panels as flat panel speakers to provide a mobile platform sound system that is more versatile than the currently employed PA systems. Furthermore, sound system 10 modulates the audio signals that drive the exciters 22 to contour the sound waves emanated from the panels 14 to thereby provide a high fidelity, full range audio environment within the passenger cabin 18.

While the invention has been described in terms of various specific embodiments, those skilled in the art will recognize that the invention can be practiced with modification within the spirit and scope of the claims.

1. A high fidelity sound system for a mobile platform, said system comprising:
a plurality of panels forming interior surfaces of a passenger cabin,
a plurality of exciters, at least one exciter affixed to selected panels, the exciters adapted to resonate the panels to generate sound waves; and
a processing center that controls the exciters so that each exciter generates sound waves having frequencies within a specific bandwidth that is based on the panel to which each exciter is affixed.

2. The system of claim 1, wherein the processing center further controls the exciters so that the amplitudes of the sound waves having frequencies near a lower outer boundary range of each bandwidth are attenuated and the sound waves having frequencies near an upper outer boundary range of each bandwidth are selectively increased or attenuated to create a smooth frequency cross-over.

3. The system of claim 2, wherein the processing center further controls the exciters so that a phase timing of the sound waves generated by each exciter is adjustable to coordinate the phase timings among all the sound waves so that sound emanating from the panels is reproduced correctly.

4. The system of claim 3, wherein the processing center includes:
a frequency equalizer that controls the frequencies of the sound waves generated by each exciter;
a cross-over point adjustment device that controls the amplitudes of the sound waves having frequencies near the outer boundaries of the bandwidths; and
a frequency delay device that controls the phase timing of the sound waves.

5. The system of claim 3, wherein the processing center includes a processor adapted to control the frequencies, the phase timing, and amplitudes of the outer boundary frequencies of the sound waves.

6. The system of claim 1, wherein the panels include at least one sidewall panel, and wherein the processing center is adapted to:
control the exciters so that sound waves generated from the sidewall panel have frequencies within a bandwidth of approximately 200 Hz to 18 kHz; and
control amplitudes of the sound waves such that the amplitudes of sound waves with frequencies between approximately 400 Hz and 15 kHz are modulated to be approximately level, while the amplitudes of sound waves having outer boundary frequencies are attenuated.

7. The system of claim 1, wherein the panels include at least one ceiling panel, and wherein the processing center is adapted to:
control the exciters so that sound waves generated from the ceiling panel have frequencies within a bandwidth of approximately 300 Hz to 18 kHz; and
control amplitudes of the sound waves such that the amplitudes of sound waves with frequencies between approximately 600 Hz and 15 kHz are modulated to be approximately level, while the amplitudes of sound waves having outer boundary frequencies are selectively increased or attenuated.

8. The system of claim 1, wherein the panels include at least one floor panel, and wherein the processing center is adapted to:
control the exciters so that sound waves generated from the floor panel have frequencies within a bandwidth of approximately 40 Hz to 12 kHz; and
control amplitudes of the sound waves such that the amplitudes of sound waves with frequencies between approximately 60 Hz and 10 kHz are modulated to be approximately level, while the amplitudes of the sound waves having frequencies within a range of approximately 40 Hz to 60 Hz are attenuated and the sound waves having frequencies within a range of approximately 8 Hz to 12 Hz are selectively increased or attenuated to create a smooth frequency cross-over.

9. The system of claim 1, wherein the exciters are distributed throughout the passenger cabin in a support array such that high fidelity sound fills a large sound field that includes all normal listening areas of the cabin.

10. A method for producing high fidelity sound within a passenger cabin of a mobile platform, said method comprising:
affixing at least one of a plurality of exciters to selected panels that form interior surfaces of the passenger cabin;
driving each exciter to resonate the panels to generate sound waves; and
processing signals that drive the exciters to contour the sound waves generated by each exciter based on the panel to which each exciter is affixed so that high fidelity sound is produced throughout the passenger cabin.

11. The method of claim 10, wherein processing the signals comprises modulating the signals so that each exciter generates sound waves having frequencies within a specific bandwidth that is based on the panel to which the exciter is affixed.

12. The method of claim 11, wherein modulating the signals comprises:
regulating the signals so that sound waves generated from the panels that form a sidewall of the passenger cabin have frequencies within a bandwidth of approximately 200 Hz to 18 kHz; and
modulating amplitudes of the sound wave such that the amplitudes of the sound waves with frequencies between approximately 400 Hz and 15 kHz are modulated to be approximately level, while the amplitudes of sound waves having outer boundary frequencies are attenuated.

13. The method of claim 11, wherein modulating the signals comprises:
regulating the signals so that sound waves generated from the panels that form a ceiling of the passenger cabin have frequencies within a bandwidth of approximately 300 Hz to 18 kHz; and
modulating amplitudes of the sound wave such that the amplitudes of the sound waves with frequencies between approximately 600 Hz and 15 kHz are modulated to be approximately level, while the amplitudes of sound waves having outer boundary frequencies are attenuated.

14. The method of claim 11, wherein modulating the signals comprises:
regulating the signals so that sound waves generated from the panels that form a floor of the passenger cabin have frequencies within a bandwidth of approximately 40 Hz to 12 kHz; and
modulating amplitudes of the sound wave such that the amplitudes of the sound waves with frequencies between approximately 60 Hz and 10 kHz are modulated to be approximately level, while the amplitudes of sound waves having outer boundary frequencies are selectively increased or attenuated.

15. The method of claim 11, wherein processing the signals comprises modulating the signals so that the amplitudes of the sound waves having frequencies near a lower outer boundary range of each bandwidth are attenuated and the sound waves having frequencies near an upper outer boundary range of each bandwidth are selectively attenuated or increased to reduce distortion caused by non-linear frequency cross-over and inability of the panels to resonate at the outer boundary frequencies, thereby creating a smooth frequency transition.

16. The method of claim 10, wherein processing the signals comprises modulating the signals so that a phase timing of the sound waves generated by each exciter is adjustable to coordinate the phase timings among all the sound waves so that sound emanating from the panels is reproduced correctly.

17. The method of claim 10, wherein, affixing the exciters to selected panels comprises attaching the exciters to selected panels throughout the passenger cabin in a support array such that high fidelity sound fills a large sound field that includes all normal listening areas of the cabin.

18. A mobile platform comprising:
a passenger cabin including a plurality of panels that form an interior surface of the passenger cabin; and
a sound system that provides high fidelity sound throughout the passenger cabin, wherein the sound system includes:
a plurality of exciters, at least one exciter affixed to selected panels throughout the passenger cabin to resonate the panels to generate sound waves; and
a processing center that processes signals that control the exciters to thereby contour the sound waves generated by each exciter based on the panel to which each exciter is affixed.

19. The mobile platform of claim 18, wherein the processing center includes a processor adapted to modulate the signals so that each exciter generates sound waves having frequencies within a specific bandwidth that is based on the panel to which the exciter is affixed.

20. The mobile platform of claim 19, wherein the panels include at least one sidewall panel and wherein the processor is further adapted to modulate the signals such that:
sound waves generated from the sidewall panel have frequencies within a bandwidth of approximately 200 Hz to 18 kHz;
amplitudes of sound waves within a range of approximately 400 Hz to 15 kHz are modulated to be approximately level; and
amplitudes of sound waves having outer boundary frequencies are progressively attenuated.

21. The mobile platform of claim 19, wherein the panels include at least one ceiling panel and wherein the processor is further adapted to modulate the signals such that:
sound waves generated from the ceiling panel have frequencies within a bandwidth of approximately 300 Hz to 18 kHz;
amplitudes of sound waves within a range of approximately 600 Hz to 15 kHz are modulated to be approximately level; and
amplitudes of sound waves having outer boundary frequencies are progressively attenuated.

22. The mobile platform of claim 19, wherein the panels include at least one floor panel, and wherein the processor is further adapted to modulate the signals such that:
sound waves generated from the floor panel have frequencies within a bandwidth of approximately 40 Hz to 12 kHz;
amplitudes of sound waves within a range of approximately 60 Hz to 10 kHz are modulated to be approximately level; and
amplitudes of sound waves having frequencies near a lower outer boundary frequency range are progressively attenuated and the sound waves having frequencies near an upper outer boundary range are selectively either increased or progressively attenuated.

23. The mobile platform of claim 19, wherein the processor is further adapted to modulate the signals so that the amplitudes of the sound waves having frequencies near a lower outer boundary range of each bandwidth are progressively attenuated and the sound waves having frequencies near an upper outer boundary range of each bandwidth are selectively either increased or progressively attenuated to reduce distortion caused by frequency cross-over and inability of the panels to resonate at the outer boundary frequencies, thereby creating a smooth frequency transition.

24. The mobile platform of claim 19, wherein the processor is further adapted to modulate the signals so that a phase timing of the sound waves generated by each exciter is adjustable to coordinate the phase timings among all the sound waves so that sound emanated from the panels is reproduced correctly.

25. The mobile platform of claim 18, wherein the processing center includes at least one of:
a frequency equalizer adapted to modulate the signals so that each exciter generates sound waves having frequencies within a specific bandwidth that is based on the panel to which the exciter is affixed;
a cross-over point adjustment device adapted to modulate the signals so that the amplitudes of the sound waves having frequencies near a lower outer boundary range of each bandwidth are progressively attenuated and the sound waves having frequencies near an upper outer boundary range of each bandwidth are selectively either increased or progressively attenuated to reduce cross-over distortion and create a smooth frequency transition; and
a frequency delay device adapted to modulate the signals so that a phase timing of the sound waves generated by each exciter is adjustable to coordinate the phase timings among all the sound waves generated from the panels so that sound emanating from the panels is reproduced correctly.

26. The mobile platform of claim 25, wherein the panels include at lease one sidewall panel, at least one ceiling panel, and at least one floor panel, and wherein the frequency equalizer is further adapted to modulate the signals such that:
sound waves generated from the sidewall panel have frequencies within a bandwidth of approximately 200 Hz to 18 kHz;
sound waves generated from the ceiling panel have frequencies within a bandwidth of approximately 300 Hz to 18 kHz; and
sound waves generated from the floor panel have frequencies within a bandwidth of approximately 40 Hz to 12 kHz.

27. The mobile platform of claim 18, wherein the exciters are affixed to selected panels throughout the passenger cabin in a support array such that high fidelity sound fills a large sound field that includes all normal listening areas of the cabin.
